(19) United States
(12) Patent Application Publication
(10) Pub. No.: US 2002/0158418 A1
(43) Pub. Date: Oct. 31, 2002

(54) Oil thrower for an exhaust-gas turbocharger

(75) Inventors: Joachim Thiesemann, Friedrichshafen (DE); Dieter Erhardt, Kressbronn (DE); Peter Stroph, Friedrichshafen (DE)

Correspondence Address: CROWELL & MORING LLP, INTELLECTUAL PROPERTY GROUP, P.O. BOX 14300, WASHINGTON, DC, 20044-4300, US

(73) Assignee: MTU Friedrichshafen GmbH.

(21) Appl. No.: 10/131,184

(22) Filed: Apr. 25, 2002

(30) Foreign Application Priority Data
Apr. 26, 2001 (DE) 101 20 539.2

(51) Int. Cl. F16J 15/40

(52) U.S. Cl. 277/423

(57) ABSTRACT

An oil thrower for an exhaust-gas turbocharger. The oil thrower has at least one first ring shoulder and one second ring shoulder. Formed between these two ring shoulders is an oil collection space. The lubricant is collected in this oil collection space at low rates of rotation. The oil thrower prevents the lubricant from ending up on the turbine wheel.

### BACKGROUND AND SUMMARY OF THE INVENTION

This application claims the priority of German Application No. 101 20 539.2, filed Apr. 26, 2001, the disclosure of which is expressly incorporated by reference herein.

The invention relates to an oil thrower for an exhaust-gas turbocharger in which a compressor is connected by a shaft with a turbine and with an oil thrower, the lubricant being drained off from a bearing of the shaft by the oil thrower.

Due to high number of revolutions per minute, the bearings of an exhaust-gas turbocharger are subjected to a high load. Therefore, they are supplied with a pressurized lubricant. During the operation of an exhaust-gas turbocharger, critical operating ranges occur, for example, when gas pressure is lacking on the turbine side or when there is a positive pressure difference from the bearings to the turbine side. In these operating areas the lubricant is sucked out of the bearings of the shaft through the seals into the turbine housing. This behavior becomes especially significant when an exhaust-gas turbocharger switches on/off during the register charging. As a secondary reaction of the lubricant leakage, the air-conducting components, for example, the air charge cooler, become soiled on the air compressor side (airside). On the turbine side, the escaping lubricant causes higher emissions and a coking of the turbine wheel.

By installing an oil thrower between the bearing and the piston ring sealing, the problem can be defused. An arrangement of this type is known, for example, from German patent 40 21 325 C1. By means of the oil thrower, the lubricant escaping from the bearing is hurled into an oil depressurization chamber. The use of the oil thrower proved its worth at moderate to high rotations per minute rate [rpm] of the exhaust-gas turbocharger. However, the low-speed range, for example below one thousand rpm, remained problematic. At this rate of speed, the lubricant was no longer completely extracted, since the effect based on centrifugal force was too low.

An object of the present invention is to optimize the seal tightness of the exhaust-gas turbocharger.

This objective is achieved according to certain preferred embodiments of the invention by arranging at least two radially extending ring shoulders on the oil thrower. This objective is also achieved according to certain preferred embodiments of the invention by providing that the oil thrower is completed from two individual oil throwers that are inextricably connected to each other.

According to a first design of the present invention, at least two radially extended ring shoulders are arranged on the oil thrower. Preferably, the ring shoulders are designed as one piece together with a hub of the oil thrower. An oil collection space is formed between the two ring shoulders. The lubricant can collect in this oil collection space at low speeds and then run off unhindered into the oil depressurization chamber. The oil collection space thus prevents the lubricant from being entrained by the flow of air and ending up in the turbocharger. The coking of the turbine wheel and the resulting imbalance are thereby effectively prevented.

In a second design form of the present invention, the oil thrower is combined of two individual oil throwers. The individual oil throwers are inextricably linked to each other on a connection surface.

It is beneficial that the oil thrower, according to the state of the art technology, can be replaced by the oil thrower made according to this invention without greater design changes to the exhaust-gas turbocharger being required for this. Since the oil thrower represents a simple component, it is economical to manufacture.

Other objects, advantages and novel features of the present invention will become apparent from the following detailed description of the invention when considered in conjunction with the accompanying drawings.

### BRIEF DESCRIPTION OF THE DRAWINGS

FIG. 1 is a cross sectional drawing of an exhaust-gas turbocharger showing the turbine side, constructed according to preferred embodiments of the invention;

FIG. 2 is a radial view of an oil thrower constructed according to a first design of the invention;

FIG. 3 is a radial view of an oil thrower constructed according to a second design of the invention;

FIG. 4 is a radial view of an oil thrower constructed according to a third design of the invention; and

FIG. 5 is a radial view of an oil thrower constructed according to a third design of the invention.

### DETAILED DESCRIPTION OF THE DRAWINGS

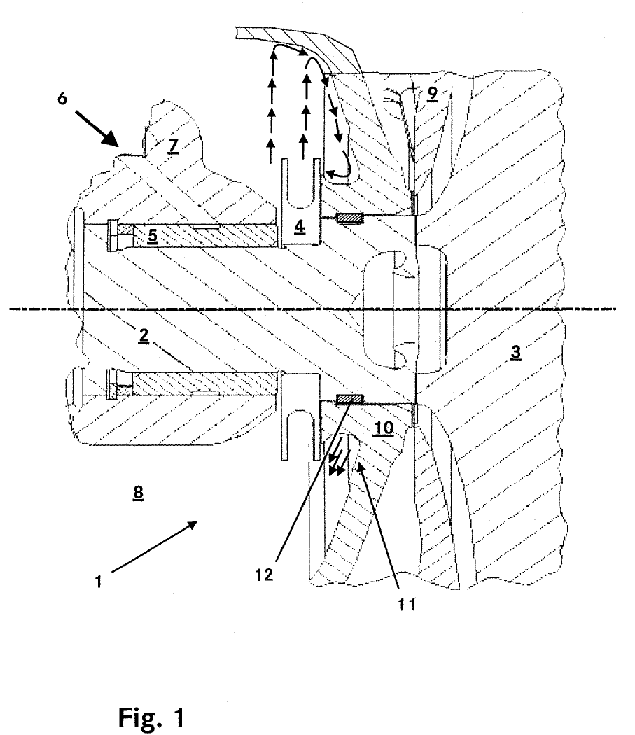

Depicted in FIG. 1 is a section drawing of exhaust-gas turbocharger 1 on the turbine side. The general function and the structure of an exhaust-gas turbocharger is assumed to be known. In FIG. 1, a shaft 2 is inextricably connected to turbine wheel 3, e.g., by friction welding. A bearing 5 on a bearing housing 7 supports shaft 2. Bearing 5 is supplied with pressurized lubricant via a lubricant port 6. A depressurization chamber 8 is partitioned from the turbine wheel 3 by a housing cover 10. A piston ring 12 is provided for sealing between housing cover 10 and shaft 2. In addition, depicted in FIG. 1 between housing cover 10 and turbine wheel 3 is a jet disk 9. Arranged between bearing housing 7 and housing cover 10 is an oil thrower 4. Oil thrower 4 is affixed to shaft 2 so as to rotate with it, e.g., by a driving fit or a form closure. Due to the high temperatures in this area, oil thrower 4 is made out of steel. When the exhaust-gas turbocharger is standing, oil thrower 4 forms a barrier against the area of piston ring 12.

The arrangement has the following functionality at high rates of rotation: The lubricant emerging from bearing 5 is picked up by oil thrower 4 and, because of the centrifugal force, is hurled in the direction of housing cover 10. Then the lubricant runs along housing cover 10 to a discharge groove 11. The lubricant is collected in this discharge groove 11 and from there goes into depressurization chamber 8. The direction of flow of the lubricant is marked in FIG. 1 using arrows.

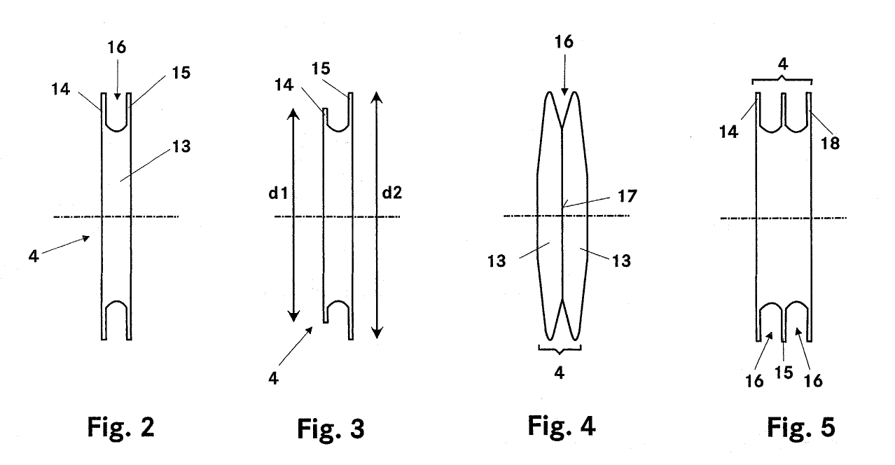

The arrangement shows the following functionality at low rates of speed [rpm]: The lubricant escaping from bearing 5 is radially conducted out on the outer side of oil thrower 4. Further explanation is now given with reference to FIG. 2, which shows the first design type of the oil thrower 4. The lubricant arrives via a first ring shoulder 14 in an oil collection space 16. The oil collection space 16 is formed by a first ring shoulder 14, a second ring shoulder 15 and a part of a hub 13 of oil thrower 4. The lubricant is picked up in this oil collection space.

In this way, the lubricant is prevented from being entrained by the air because of the pressure difference between depressurization chamber 8 and turbine wheel 3. The lubricant goes from this oil collection space 16 into depressurization chamber 8.

Depicted in FIG. 3 is a second design type of the oil thrower 4. In this design, first ring shoulder 14 has a diameter d1 and second ring shoulder 15 has a diameter d2 . The diameters are configured differently. Preferably, diameter d2 is the greater of the two. The description of FIG. 1 or FIG. 2 applies to the functionality in this case.

Depicted in FIG. 4 is a third design type of oil thrower 4. In this design, oil thrower 4 is made up of two individual disks whose hub, reference number 13, is adjacent to a connection surface 17. The two individual oil throwers are inextricably connected to each other on this connection surface 17.

Depicted in FIG. 5 is a fourth design type of oil thrower 4. Depicted in this oil thrower 4 are three ring shoulders, reference numbers 14, 15, and 18. Arranged between these ring shoulders are two oil collection spaces 16. The description of FIG. 1 or FIG. 2 applies to the functionality in this case.

A practically complete oil sealing between bearing housing 7 and turbine wheel 3 has been achieved through this invention. As a result, no lubricant can come from bearing housing 7 and end up on hot turbine wheel 3 and change into coke there. The formation of a coating on the turbine wheel is thus effectively prevented. As is generally known, formation of a coating on turbine wheel 3 can lead to imbalance and in the extreme case to a breakage of shaft 2. Coking in the area of piston ring 12 can lead to jamming and thus to a partial damage to the shaft. Overall, the operational reliability of the exhaust-gas turbocharger is thus increased.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An oil thrower for an exhaust-gas turbocharger in which a compressor is connected by a shaft with a turbine and with an oil thrower; the lubricant being drained off from a bearing of the shaft by the oil thrower, wherein at least two radially extending ring shoulders are arranged on the oil thrower.

2. The oil thrower as recited in claim 1, wherein the oil thrower has an oil collection space.

3. The oil thrower as recited in claim 2, wherein the oil collection space is formed by a first ring shoulder, a second ring shoulder and a section of a hub of the oil thrower.

4. The oil thrower as recited in claim 1, wherein the radius o f a first ring shoulder is configured with a length different from that of the radius of a second ring shoulder.

5. The oil thrower as recited in claim 2, wherein the radius of a first ring shoulder is configured with a length different from that of the radius of a second ring shoulder.

6. The oil thrower as recited in claim 3, wherein the radius of a first ring shoulder is configured with a length different from that of the radius of a second ring shoulder.

7. The oil thrower as recited in claim 1, wherein the first and second ring shoulders are designed as one piece together with a hub of the oil thrower.

8. The oil thrower as recited in claim 1, wherein the oil thrower is affixed to the shaft so as to rotate together with it.

9. The oil thrower as recited in claim 2, wherein the oil thrower is affixed to the shaft so as to rotate together with it.

10. The oil thrower as recited in claim 3, wherein the oil thrower is affixed to the shaft so as to rotate together with it.

11. The oil thrower as recited in claim 4, wherein the oil thrower is affixed to the shaft so as to rotate together with it.

12. The oil thrower as recited in claim 7, wherein the oil thrower is affixed to the shaft so as to rotate together with it.

13. An oil thrower for an exhaust-gas turbocharger in which a compressor is connected by a shaft with a turbine and with an oil thrower, lubricant being drained off from a bearing of the shaft by the oil thrower, wherein the oil thrower is completed from two individual oil throwers that are inextricably connected to each other.

14. The oil thrower as recited in claim 6, wherein the oil throwers are inextricably connected to each other at hubs via connection surfaces.

15. The oil thrower as recited in claim 13, wherein the oil thrower is affixed to the shaft so as to rotate together with it.

16. The oil thrower as recited in claim 14, wherein the oil thrower is affixed to the shaft so as to rotate together with it.

17. An exhaust gas turbocharger assembly comprising:
a turbine wheel,
a turbine shaft rotatably fixed to the turbine wheel,
a bearing rotatably supporting the turbine shaft at a location spaced axially from the turbine wheel,
means for supplying lubricating oil under pressure to the bearing, and
an oil thrower disposed surrounding the turbine shaft at an axial location between the bearing and the turbine wheel, said oil thrower including first and second radially extending ring shoulders defining one oil collection space therebetween.

18. An assembly according to claim 17, wherein the oil collection space is formed by a first ring shoulder, a second ring shoulder and a section of a hub of the oil thrower.

19. An assembly according to claim 18, wherein the radius of the first ring shoulder is configured with a length different from that of the radius of the second ring shoulder.

20. An assembly according to claim 17, wherein the first and second ring shoulder are designed as one piece together with a hub of the oil thrower.

21. A method of operating the assembly according to claim 17, comprising collecting oil in said oil collection space at low operating speeds of the turbine shaft.
